(19) United States
(12) Patent Application Publication
(10) Pub. No.: US 2011/0260635 A1
(43) Pub. Date: Oct. 27, 2011

(54) METHOD OF IGNITING A LAMP, CONTROLLER FOR A LAMP, AND A LAMP CONTROLLED BY A CONTROLLER

(75) Inventors: Henricus Theodorus Petrus Johannes van Elk, Ravenstein (NL); Jeroen Kleinpenning, Lent (NL)

(73) Assignee: NXP B.V., Eindhoven (NL)

(21) Appl. No.: 13/142,263

(22) PCT Filed: Dec. 21, 2009
(86) PCT No.: PCT/IB09/55889

§ 371 Date: Jun. 24, 2011

(30) Foreign Application Priority Data
Dec. 31, 2008 (EP) 08106044.4

(51) Int. Cl. H05B 37/02

(52) U.S. Cl. 315/226

(57) ABSTRACT

A method of igniting a lamp is disclosed. The lamp may be a compact fluorescent lamp. The method is directed in particular to reducing or eliminating hard-switching of half-bridge switches driving a lamp. The method operates by reducing the on-time of at least one of the switches, in response to saturation of the ballast inductor. The method can operate immediately upon saturation of the ballast inductor, or allow a predetermined level of saturation. The method operates by increasing the slope of the sawtooth timing circuit.

### FIELD OF THE INVENTION

This invention relates to a method of igniting a lamp. Such a lamp may be, for example, a compact fluorescent lamp. It further relates to a circuit arrangement for a lamp, and to a lamp such as a fluorescent lamp or a compact fluorescent lamp, including such a circuit arrangement.

### BACKGROUND OF THE INVENTION

With an increasing drive towards energy-efficient lighting, lamps based on fluorescence rather than incandescence are increasingly important. However, in many situations, a commercially viable product must be similar in the size or form to existing incandescent lightbulbs. Compact fluorescent lamps (CFL) have been developed to meet such a need.

The ignition of such lamps requires an electrical supply with significantly different characteristics to that of the supply during normal operation. In order to meet such requirements, such lamps are often supplied with a ballast coil or inductor in series between the lamp and a switched power supply, together with a ballast capacitor connected across the lamp. The ballast coil or inductor forms part of a resonant tank circuit along with the ballast capacitor. Hereinafter the terms ballast coil and ballast inductor will be used interchangeably.

An example of a CFL including a resonant tank circuit and driven by a half bridge is shown in FIG. 1. FIG. 1 shows a lamp 1 such as a compact fluorescent lamp with a ballast capacitor C_{ballast} across the lamp. One end of the lamp is held at half the DC supply voltage (V_{DC}) by means of a capacitive divider comprising two capacitors C1 and C2. The other end of the lamp, that is the lamp burner node 101, is series connected to the half bridge node V_{HB} of a half bridge supply via a ballast inductor coil L_{ballast}. The half bridge supply comprises a pair of FETs, being high side switch (HSS) 2 and low side switch (LSS) 3, which are shown along with their integral body, or back gate, diodes HSD and LSD respectively. The respective gates of the switches, GHS and GLS, are driven by drivers 4 and 5. The source of low side switch 3 is connected to ground by means of a shunt resistor Rsh.

During an ignition phase of the lamp, large coil currents occur, as the oscillator frequency sweeps down towards the resonant tank (L_{ballast}+C_{ballast}) resonance frequency. As a result, the coil can reach saturation. The insert to FIG. 1 shows the voltage across Rsh, during a half cycle whilst the low side switch 3 is on (i.e. closed). The voltage increases in a sawtooth fashion, until it reaches a voltage (V_{LSAT}) at which the ballast inductor becomes saturated. The gradient of the voltage then increases and there follows a voltage spike.

When the coil current has saturated, the effective coil inductance decreases. As a result, the resonant frequency of the resonant tank shifts upwards, and there is a corresponding fast phase shift. This can result in a reduced current slope, and within just a few cycles, the slope of the current can become negative, resulting in capacitive mode operation. As a result, zero voltage switching or so-called “soft-switching” no longer occurs, but there is “hard switching” with extreme current spikes. This is illustrated in FIG. 2.

FIG. 2a (left hand side) shows the variation in time or four parameters: the source current of the LSS 3, which corresponds to VRsh, is shown at 201, and follows a generally sawtooth shape whilst the low side switch 3 is on, and is zero whilst the low side switch 3 is off. The half bridge voltage (V_{HB}) is shown at 202, and follows a generally square waveform; the voltage at the CFL burner node 101 is shown that 203, and oscillates generally sinusoidally; finally, the DC supply voltage, which is generally nearly constant is shown at 204.

Towards the right side of FIG. 2(a), and in more detail in FIG. 2(b), is shown the effect of current saturation in the inductor. Increasingly large current spikes 201a, 201b and 201c start to develop during successive cycles. The resulting hard switching, in which HSS switch 2 is closed whilst the body diode of the LSS switch 3 is conducting to provide reverse recovery, can be damaging to the FET, and can even cause it to fail.

It is therefore necessary to provide measures to avoid such capacitive mode switching. Since the saturation of the lamp coil can result in a fast change to the resonant frequency, and thus a change from inductive mode to capacitive mode within a few cycles, it is necessary to create a frequency control that reacts very quickly, and the relatively slow frequency control which is conventionally used for capacitive mode detection is not adequate.

The best solution to this problem is to provide a direct cycle-by-cycle control of the oscillator, to keep up with this sudden phase shift. Normally, for lamps that such as CFL lamps, a sawtooth oscillator is used as a controller oscillator. A first known prior art solution is to reset the sawtooth oscillator immediately upon detection of current saturation in the inductor—that is, immediately it is detected that the current in the inductor has reached a level to result in the magnetic field in the inductor becoming saturated, such that additional current does not results in further linear increase in the magnetic field.

Changing the phase of the oscillator can be realised by increasing its charge current, I_{Cf}. This extra current in the sawtooth oscillator makes its slope substantially steeper, once coil saturation is detected, and creates the necessary phase shift. In a second known solution, such as disclosed in European patent EP-B-1,593,290, a charge detection circuit is used to detect saturation and increase the sawtooth slope, during, and only during, saturation. The charge current increase in this prior art solution is adapted to reflect the excess current, which results in a current controlled phase shift which operates only whilst there is excess charge, to guarantee a relatively fast reset of the sawtooth oscillator.

The known prior art solutions either minimise or diminish the peak of the coil saturation; however, it is desirable to be able to allow for some level of saturation, as this (excess saturation) current also flows in the ballast capacitor over the lamp. This would result in a much steeper rate of change of the ignition the voltage (ΔV/ΔT), and a consequent short faster rise in the ignition amplitude. The time to ignition could be thereby reduced.

It is thus an object of the present invention to provide an alternative method of control of an ignition phase of the lamp, which allows for the greater flexibility of control.

### SUMMARY OF THE INVENTION

According to a first aspect of the invention there is provided a method of controlling a controller for a lamp, the controller having an inductor connectable in series between the lamp and a half-bridge node which half-bridge node is between a first switch and a second switch, the method comprising: alternately closing the first and second switches for respective first and second periods and with a soft-switching interval therebetween; controlling at least one of the first and second periods by means of a comparison between a signal derived from an output of a saw-tooth generator and a first predetermined reference signal; and during the first period: comparing an indicator signal (VRsh) indicative of current in the inductor with a second predetermined reference signal (V_{LSAT}) and increasing a slope of the output of the saw-tooth generator to a steeper slope in response to the indicator signal (VRsh) being greater than the second predetermined reference signal (V_{LSAT}) and thereafter maintaining the steeper slope until the first switch is opened or the sawtooth generator is reset.

Since the method of this aspect of the invention provides control in response to a predetermined reference signal, the method provides for flexibility of control.

Preferably, the step of increasing the slope of the saw-tooth generator comprises increasing the slope by a factor of more than 2. This enables the circuit to protect against capacitive mode operation.

In embodiments the slope of the sawtooth generator is increased immediately on detection of any magnetic saturation in the coil. The magnetic saturation arises due to the current through the coil, and the term ‘current saturation’ will hereinafter be used interchangeably. Alternatively, the slope of the sawtooth generator is increased on detection of current saturation in the coil by between 25% and 75%, or by between 75% and 125% even on detection of current saturation in the coil by more than 125%, and preferably within a range of 25%-50%, thereby ensuring the current does not peak too early or sharply. These embodiments thus provide for a degree of flexibility of control.

Preferably the current saturation is measured by means of a measuring voltage across a series resistor between a one of the first and second switches and ground. Measuring such a shunt voltage provides a good proxy for the coil current.

Preferably, the soft-switching interval is non-zero. Inclusion of such a non-zero soft switching interval avoids hard switching. However and less preferably, for suitably chosen FETs, the soft switching interval may be zero.

In embodiments, the first switch is opened in response to the output of the saw-tooth exceeding the reference signal. Alternatively or in addition, the saw-tooth generator may be reset in response to an ending of current saturation in the coil. The first switch may then be opened either directly or after a delay, in response to the ending of the current saturation. A post peak current reset facility may thereby be provided, which can provide the designer or user with a further degree of control.

In embodiments, there may be a method described above, and further comprising the steps of, during the second period: comparing an indicator signal (VRsh) indicative of current in the inductor with the second predetermined reference signal (V_{LSAT}) and increasing a slope of the output of the saw-tooth generator to a steeper slope in response to the indicator signal (VRsh) being greater than the second predetermined reference signal (V_{LSAT}) and thereafter maintaining the steeper slope until the second switch is opened. The reduction in the switch on-time may thereby beneficially be balanced between the first and second switch. Other methods of balancing the on-time reduction, or none at all, may alternatively be provided.

In embodiments the step of increasing a slope of the saw-tooth generator to a steeper slope in response to current saturation in the coil is enabled only when the controller is in an ignition phase. Beneficially, this may preclude the method interfering with other phases of operation of a lamp.

In embodiments the lamp is a compact fluorescent lamp; alternatively, the lamp may be a non-compact fluorescent lamp, or another type of lamp. According to another aspect of the invention there is provided a circuit arrangement for a lamp configured to operate according to a method as described above. The invention, also extends, without limitation, to a compact fluorescent lamp comprising a controller of described above.

These and other aspects of the invention will be apparent from, and elucidated with reference to, the embodiments described hereinafter.

### BRIEF DESCRIPTION OF DRAWINGS

Embodiments of the invention will be described, by way of example only, with reference to the drawings, in which

FIG. 1 is a simplified schematic of a half-bridge driven lamp;

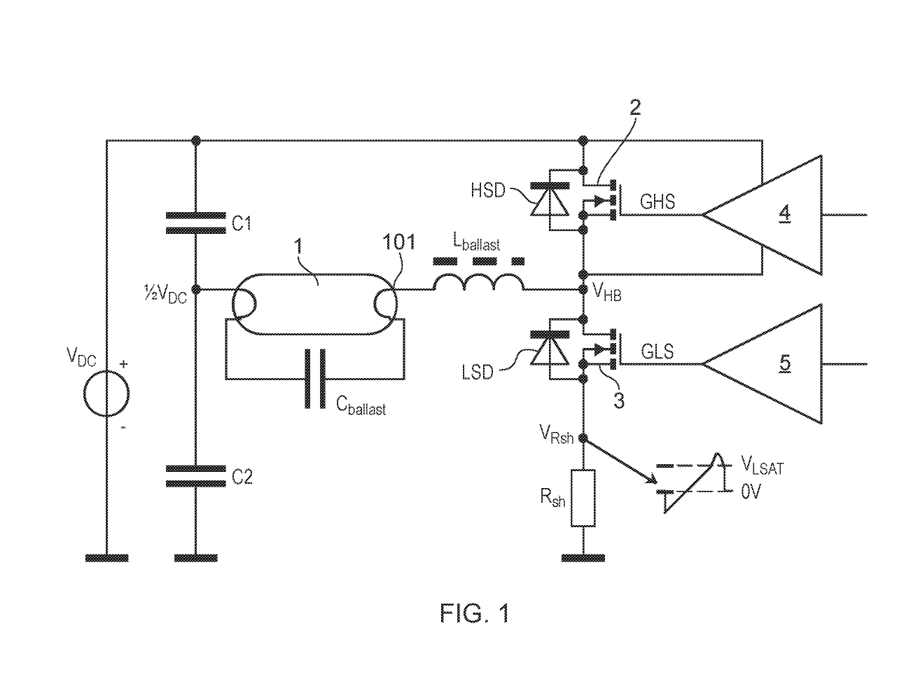

FIG. 2 is a timing diagram for the circuit schematically shown in FIG. 1, with the timing diagram shown in overview at FIG. 2(a) and partially in more detail at FIG. 2(b);

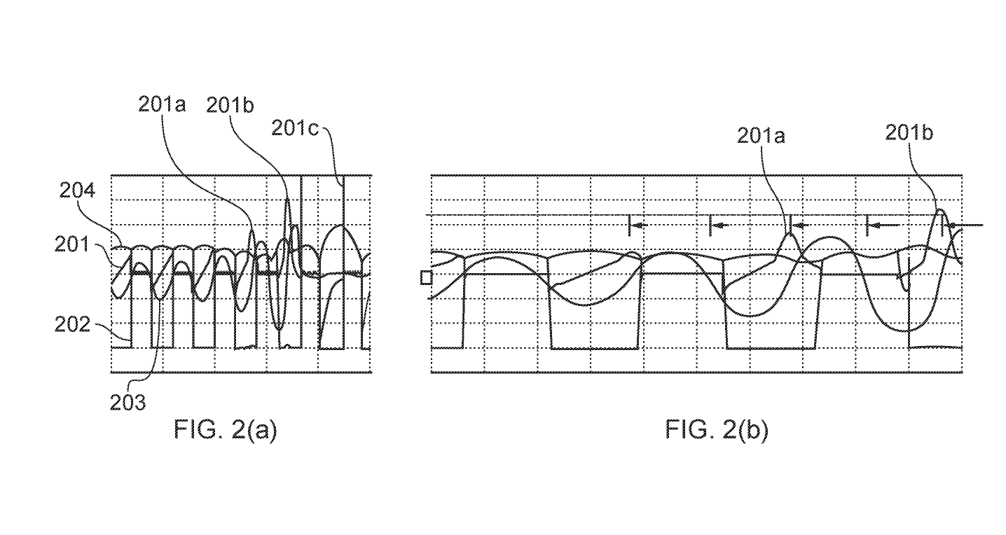

FIG. 3 shows a simplified schematic of a half bridge driven lamp with a controller according to the prior art;

FIG. 4 is a timing diagram of the circuit schematically shown in figure including a possible alternative timing;

FIG. 5 shows a schematic of a half-bridge driven lamp with a controller according to an embodiment of the invention;

FIG. 6 shows, at 6(a) and 6(c), two alternatives for saturation reduction circuits with ignition state enable, and at 6(b) corresponding timing diagram;

FIG. 7 shows a schematic of a half bridge driven lamp with a controller according to another embodiment of the invention; and

FIG. 8 shows the timing diagram of embodiments of the invention.

It should be noted that the Figures are diagrammatic and not drawn to scale. Relative dimensions and proportions of parts of these Figures have been shown exaggerated or reduced in size, for the sake of clarity and convenience in the drawings. The same reference signs are generally used to refer to corresponding or similar feature in modified and different embodiments

### DETAILED DESCRIPTION OF EMBODIMENTS

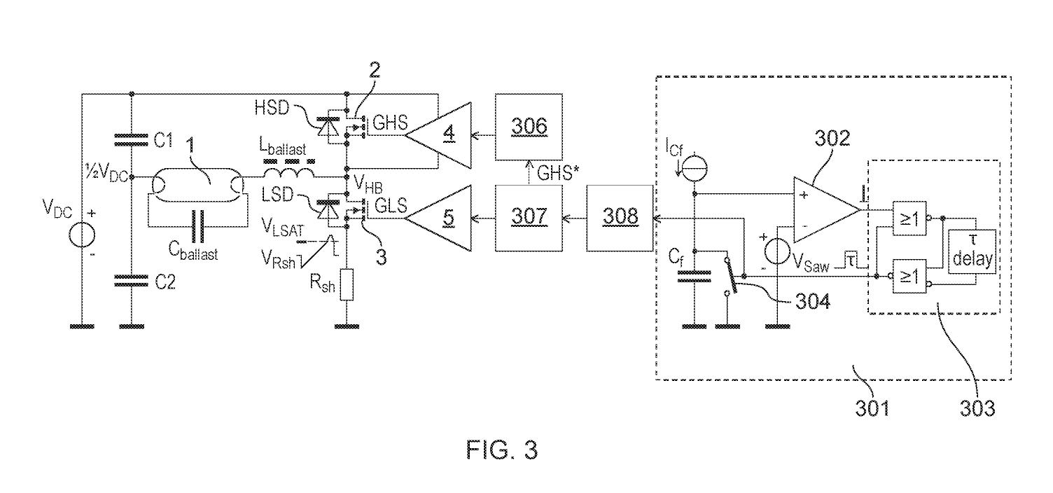

FIG. 3 shows a simplified schematic of a conventional half-bridge driving a compact fluorescent lamp with a controller using a sawtooth oscillator. In the figure, a conventional sawtooth oscillator 301 comprises a current source Icf, which charges a capacitor Cf. The capacitor voltage increases until it exceeds the first predetermined reference voltage Vsaw, the comparison being made in comparator 302. Once the voltage exceeds Vsaw, switch 304 is opened to discharge the capacitor, the discharge period τ being set by delay logic 303. The output from the sawtooth generator is directed to the divide-by-two logic 308, in order to halve its frequency, and thence to logic 307 to control the low side switch driver 5. A second output from the driver logic 307 is directed to a level shift 306 and thence to the high side switch driver 4.

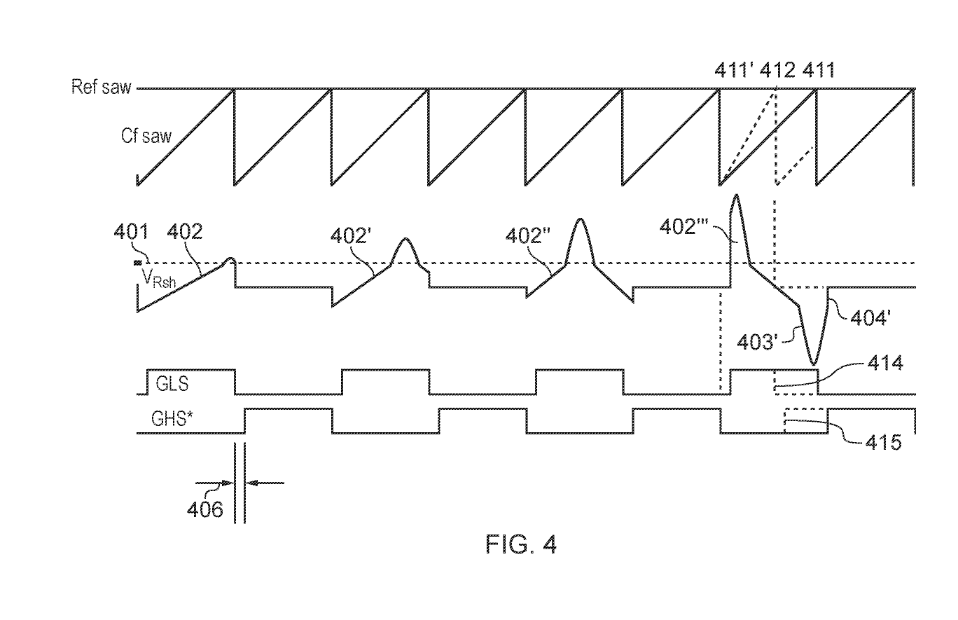

A timing diagram for the circuit of FIG. 3 is shown in FIG. 4, during an ignition phase. FIG. 4 shows, in solid lines starting at the bottom, the timing of the high side and low side switches 2 and 3 according to the gate signals GHS and GLS respectively, the voltage V_{Rsh} across the shunt resistor, and the voltage across the sawtooth capacitor Cf. For the switches, a ‘high’ signal indicates that the switch is closed (i.e. it is “on”), and there is a gap 406 between one of switches being opened and the other being closed, to allow zero-voltage or soft-switching; the voltage V_{Rsh} across the shunt resistor is indicative of the inductor current, and is shown relative to the level 401 at which the inductor starts to saturate; and the sawtooth Cf is reset when the voltage reaches a reference level ‘Ref_saw’.

When the low side switch 3 is closed, the coil current V_{Rsh} increases linearly, starting from a negative value. During successive cycles, the coil current exceeds the threshold value 401 progressively earlier (since the effective inductance of the coil is decreasing, the positive slope of the current, shown at 402, 402′, 402″ is increasingly high). Thus the coil current exceeds the threshold level by increasingly large amounts resulting in progressively earlier and sharper spike in current. Further, the saturation of the inductor increases the momentary frequency, and if this frequency exceeds the half bridge switching frequency oscillatory, As a result, the current can start to fall before the low side switch 3 is opened, the area of the current spike being related to the coil resistance. If the current goes negative before the low side switch 3 is opened, when that switch is opened a reverse current can flow through its body diode, as shown at 403, 403′. This can result in a hard switch-on, shown at 404, 404′, when the high side switch 2 is switched on. This can ultimately result in damage to the switch 2, and failure of the system.

The effect of increasing the slope of the sawtooth, according to a first aspect of the present invention, is shown in the dashed lines. The increased gradient of Cf_saw, 411′, relative to its unadjusted gradient 411, results in it reaching the reference level Ref_saw earlier, at 412. Despite the presence of an early peak 402″' in the coil current, the current does not go negative before moment 412. The low side switch 3 is switched off at this moment, the trailing edge of the switch being indicated at 414, and the highside switch is turned on subsequently, after the usual soft-switching delay 406. By this means hard switching is avoided and the peak current is limited. Thus the increased gradient of the coil current is maintained until the low side switch is switched off.

To prevent hard switching and limit the maximum level of the current peak, the increase in the momentary frequency of the oscillator circuitry should preferably be more than a factor of two; this can account for the worst-case situation as shown in FIG. 4, wherein the ballast load acts in a capacitive mode rather an inductive manner.

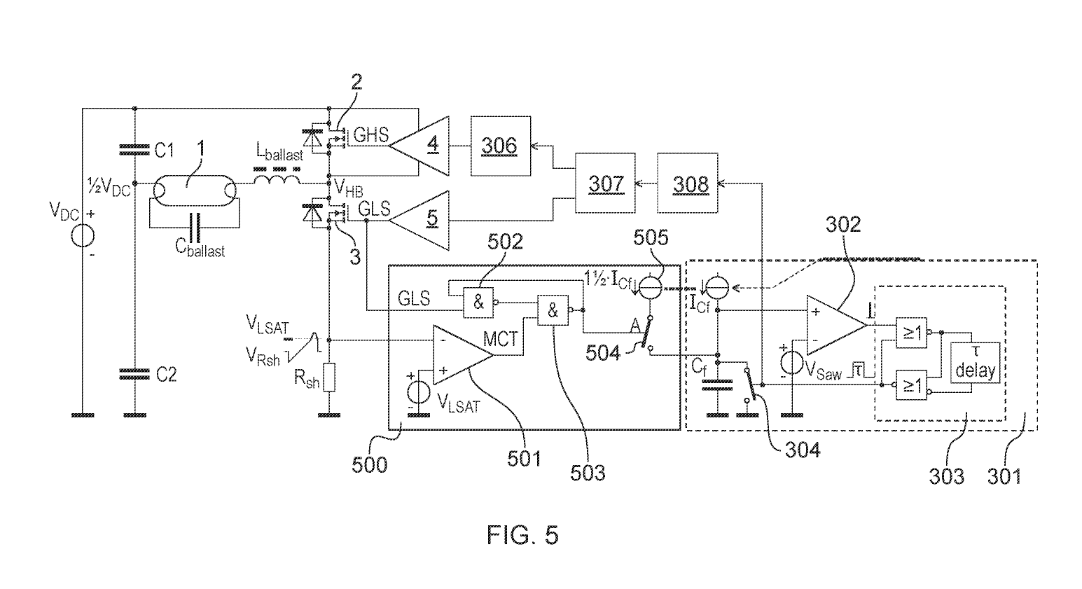

FIG. 5 shows a schematic diagram of a lamp controller according to an aspect of the present invention. In addition to the current generator I_{Cf} of the sawtooth generator 301, there is provided further circuitry 500, which switches an additional current generator 505. The circuit 500 comprises a comparator 501, which compares the coil current as determined by V_{Rsh} at its negative input, with a second predetermined threshold value V_{LSAT} at its positive input. The output of the comparator, which output corresponds to a maximum current trigger (MCT), is provided as an input into a set-reset flip-flop which is formed of a pair of NAND gates 502 and 503. The second input into the set-reset flip-flop is taken from the gate drive signal GLS to low side switch 3. The flip-flop controls, at its output ‘A’, a switch 504, which is arranged to switch second current generator 505 in parallel with the first current generator in sawtooth oscillator 301.

In operation, the circuit 500 operates to compare the coil current with the threshold value of V_{LSAT}. Once the coil current exceeds the threshold value V_{LSAT}, the output of the comparator MCT goes low. This transition sets the set reset flip-flop so signal A becomes high and remains so, irrespective of the GLS signal, so long as MCT remains low. Only once the MCT has gone high, by virtue of the coil current falling below V_{LSAT}, is it possible for the flip-flop to be reset by a high-to-low transient in GLS. All the time that signal A is high, the switch 504 introduces the additional current from current generator 505 into the sawtooth oscillator. As shown in the example FIG. 5, the additional current is equal to 1.5×I_{Cf}. Thus, including the additional current, the current in the sawtooth generator is now 2.5 times what it would otherwise be. A further effect of the circuit just described is that the ON-time control for the LSS switch 3 is adaptive and affected from the moment of the current exceeding the threshold V_{LSAT} until the end of the period during which LSS 3 is on.

It will be immediately apparent to the skilled reader that the additional current could be equal to a different level, such as 1.0×I_{Cf}. It is preferable, but not mandatory, that the additional current is at least 1×I_{Cf}: this will result in a doubling of the frequency of the sawtooth, and if the increase in the saw-tooth slope results in at least a doubling in the frequency, this will prevent hard switching and limits the level of the peak current, even in the worst case in which the ballast load acts in a capacitive mode rather than inductive mode.

The above embodiment has been tested using a range of comparator levels V_{LSAT}. Choosing a value of V_{LSAT} which is close to the actual level where the coil saturation starts has been found to extend the ignition time, whilst avoiding any hard switching prior to ignition. Further, the actual peak currents prior to ignition remain at a moderate level, just above the comparison level V_{LSAT}. Increasing the difference between the comparator level V_{LSAT} and the actual saturation level results in faster ignition, at the price of somewhat larger saturation peak current levels. Thus it is apparent that by adjusting the comparison level V_{LSAT}, it is possible to control the maximum peak current even beyond magnetic saturation, whilst in all cases avoiding hard switching currents prior to ignition. Experimentally, it has been observed that even when the comparison level V_{LSAT} is more than a factor of two compared with the actual level were coil saturation starts, hard switching currents can still be avoided.

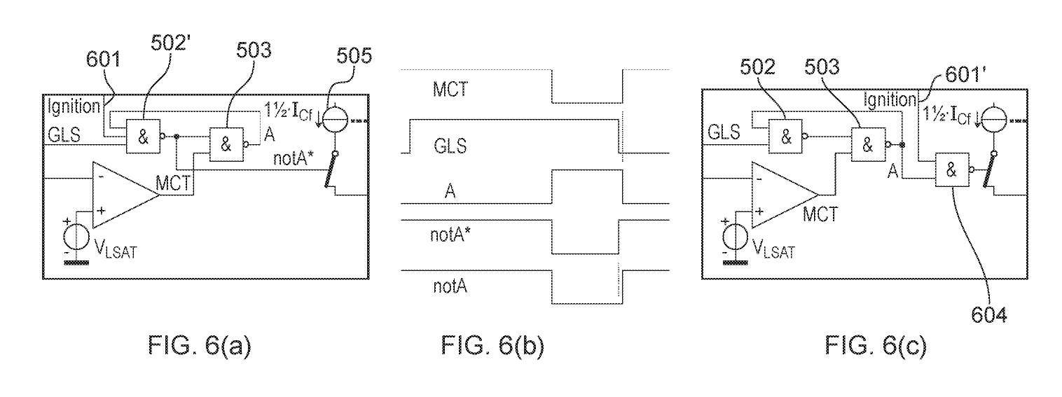

In a further embodiment of the invention, the saturation reduction circuit 500 described above is disabled when the controller is outside of the ignition state. FIG. 6(a) and FIG. 6(c) show two, non-limiting, ways of implementing this concept by disabling the additional current generator from the sawtooth. In FIG. 6(a), the set-reset flip-flop is modified by introducing a further input 601 into the first NAND gate 502′, and the output NOT(A*) is used rather than A to switch the additional current generator 505. The further input 601 corresponds to the ignition state and thus is high whenever the control is in the ignition state. Alternatively, in the implementation of FIG. 6(c), the output A from the set reset flip-flop is used, but this is inverted to produce output NOT(A) in a further NAND gate 604, the further NAND gate 604 having as a second input the ignition state 601′.

In either implementation, the corresponding timing diagram is as shown in FIG. 6(b). FIG. 6 shows the status of the maximum current trigger MCT, low side switch gate GLS, flip-flop output a, the flip-flop inverted output and NOT(A*), and flip-flop inverted output NOT(A). As can be seen, output A goes high (and outputs NOT(A*) and NOT(A) go low), upon the falling edge of MCT, where GLS is already high. When GLS goes low, output NOT(A*) goes high. After a small delay, MCT returns high, at which time output A goes low and output NOT(A*) high. The small delay is determined by the delay between the descending edge of the LSS gate switching signal from driver 5, and the actual moment that the switch turns off. It is possible, although not mandatory, that this delay it can be advantageously used to also increase the start of the succeeding sawtooth slope, and thus improve the balance between the HSS and LSS, for the cycle time production.

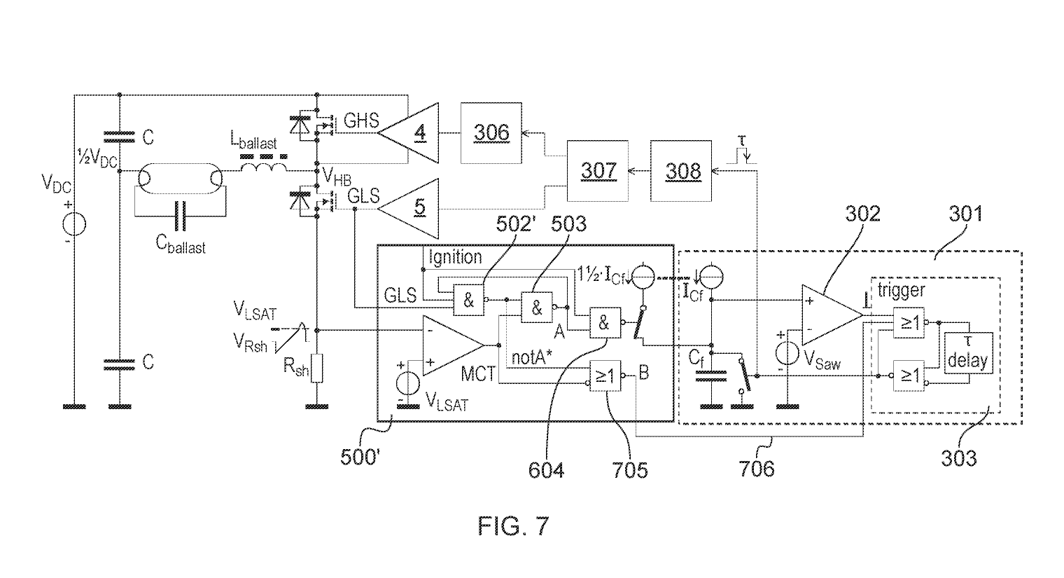

Another embodiment of the invention is shown in FIG. 7. This embodiment is similar to that described with reference to FIG. 5, and incorporates both of the modifications described with reference to FIGS. 6(a) and 6(b), together with additional circuitry to provide a post saturation peak reset for the sawtooth oscillator. Thus a NOR gate 705 is provided with, as a first input, the signal NOT(A*), and as a second input, an inverted MCT signal, that is NOT(MCT). The output B from the NOR gate 705 is directed to the delay logic 303, to reset the sawtooth oscillator just after the saturation peak. By this implementation, it can be guaranteed that the B pulse always precedes the descending edge of the GLS signal.

In most cases, it will not be necessary to reset the sawtooth oscillator, provided that the comparator level V_{LSAT} is kept close to the actual level at which coil saturation starts. However, this post peak reset has the advantage of allowing a coil saturation peak and switching over from the low side switch to the high side switch at an acceptably high current level, whilst still excluding the major part of the descending slope from the current also of the low side switch.

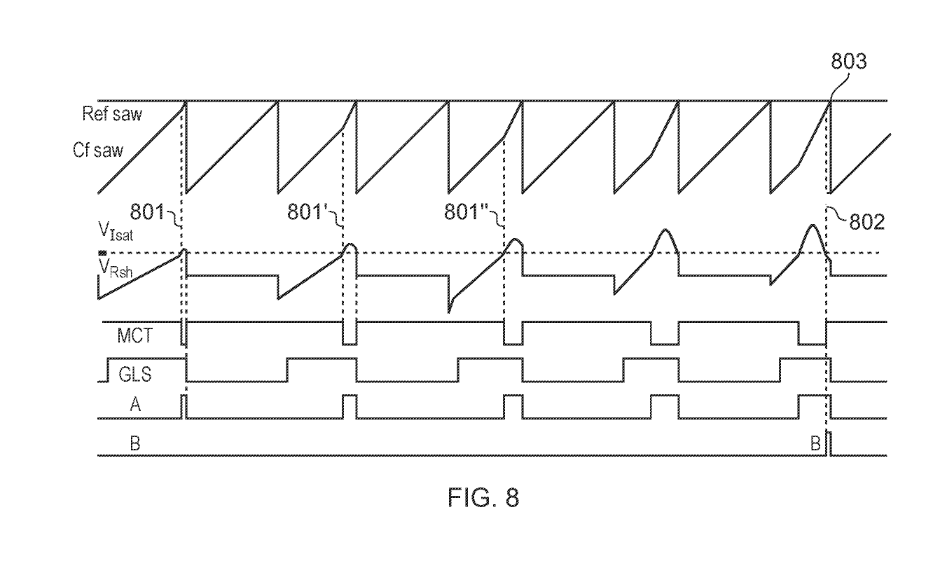

The timing diagram of embodiments of the invention will now be described with reference to FIG. 8. FIG. 8 shows, from the bottom, the signal B (which corresponds to the output of NOR gate 705), signal A (which corresponds to the output of set reset flip-flop 502′ 503), the low side switch 3′s gate signal GLS, maximum current trigger signal MCT, source current of the low side switch VRsh which is also indicative of the ballast coil current, and the output Cf saw from the sawtooth generator. Reference level ‘Ref_saw’ for the sawtooth generator, and comparison level V_{LSAT} are also shown.

As shown at moment 801, 801′, 801″, where the coil current VRsh exceeds the comparison level V_{LSAT}, MCT goes low and the slope of the sawtooth output Cf_saw increases, and pulse A also starts by going high. Once the sawtooth output Cf_saw reaches the reference level (Ref saw), MCT goes high and GLS goes low, pulse A is concluded by going low, and the sawtooth is reset. This corresponds to the embodiments described with reference to FIGS. 5 and 6.

The cycle on the right-hand side of FIG. 8 demonstrates the effect of including the modification described above with reference to FIG. 7. As above, MCT goes low and A goes high to increase the slope of Cf_saw, once VRsh reaches the comparison level V_{LSAT}. However, in this instance, the current peak concludes and VRsh starts to fall below V_{LSAT} at a moment 802, which is prior to the moment at which the sawtooth output Cf_saw would have reached the reference level Ref_saw at moment 803. At this moment 802, the (optional) post-saturation peak reset mechanism kicks in—that is MCT goes high, as does B, and the sawtooth is reset. It is to be noted that although the sawtooth Cf_saw is reset, the LSS 3 is not immediately opened, and the timer for the period during which the HSS 2 should be on is not immediately restarted. Instead, there is a delay until the end of the pulse B, and at the end of this pulse the signal A goes low as does GLS, to open the LSS 3. Further, only at the end of the pulse B does the saw-tooth Cf_saw start to rise again. The duration of pulse B is determined by a timing delay τ (not shown in this figure). As a result, the post-peak reset does not reduce the on-time for either the LSS or the HSS,

In summary then, from one viewpoint a method of igniting a lamp is disclosed. The lamp may be a compact fluorescent lamp. The method is directed in particular to reducing or eliminating hard-switching of half-bridge switches driving a lamp. The method operates by reducing the on-time of at least one of the switches, in response to saturation of the ballast inductor. The method can operate immediately upon saturation of the ballast inductor, or allow a predetermined level of saturation. The method operates by increasing the slope of the sawtooth timing circuit.

From reading the present disclosure, other variations and modifications will be apparent to the skilled person. Such variations and modifications may involve equivalent and other features which are already known in the art of methods for controlling lamps, and which may be used instead of, or in addition to, features already described herein.

Although the appended claims are directed to particular combinations of features, it should be understood that the scope of the disclosure of the present invention also includes any novel feature or any novel combination of features disclosed herein either explicitly or implicitly or any generalisation thereof, whether or not it relates to the same invention as presently claimed in any claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub-combination.

The applicant hereby gives notice that new claims may be formulated to such features and/or combinations of such features during the prosecution of the present application or of any further application derived therefrom.

For the sake of completeness it is also stated that the term “comprising” does not exclude other elements or steps, the term “a” or “an” does not exclude a plurality, a single processor or other unit may fulfil the functions of several means recited in the claims and reference signs in the claims shall not be construed as limiting the scope of the claims.

1. A method of controlling a controller for a lamp, the controller having an inductor (L_{ballast}) connectable in series between the lamp and a half-bridge node which half-bridge node is between a first switch and a second switch,
the method comprising:
alternately closing the first and second switches for respective first and second periods and with a soft-switching interval therebetween;
controlling at least one of the first and second periods by means of a comparison between a signal derived from an output of a saw-tooth generator and a first predetermined reference signal;
and during the first period:
comparing an indicator signal (VRsh) indicative of current in the inductor with a second predetermined reference signal (V_{LSAT}) and
increasing a slope of the output of the saw-tooth generator to a steeper slope in response to the indicator signal (VRsh) being greater than the second predetermined reference signal (V_{LSAT}) and thereafter
maintaining the steeper slope until the first switch is opened or the sawtoooth generator is reset.

2. A method as claimed in claim 1, wherein the step of increasing the slope of the saw-tooth generator comprises increasing the slope by a factor of more than 2.

3. A method as claimed in claim 1, wherein the slope of the sawtooth generator is increased immediately on detection of any magnetic saturation in the coil.

4. A method as claimed in claim 1, wherein the slope of the sawtooth generator is increased on detection of current saturation in the coil by between 25% and 75%.

5. A method as claimed in claim 1, wherein the slope of the sawtooth generator is increased on detection of current saturation in the coil by one of between 75% and 125%, rand by more than 125%.

6. A method as claimed in claim 1, wherein the current saturation is measured by measuring a voltage across a series resistor between the first switch and ground.

7. A method as claimed in claim 1, wherein the soft-switching interval is non-zero.

8. A method as claimed in claim 1, wherein the first switch is opened in response to the output of the saw-tooth exceeding the reference signal.

9. A method as claimed in claim 1, wherein the saw-tooth generator is reset in response to an ending of current saturation in the coil.

10. A method as claimed in claim 1, further comprising the steps of, during the second period:
comparing an indicator signal indicative of current in the inductor with the second predetermined reference signal and
increasing a slope of the output of the saw-tooth generator to a steeper slope in response to the indicator signal being greater than the second predetermined reference signal and thereafter
maintaining the steeper slope until the second switch is opened.

11. A method as claimed in claim 1, wherein the step of increasing a slope of the saw-tooth generator to a steeper slope in response to current saturation in the coil is enabled only when the controller is in an ignition phase.

12. A method as claimed in claim 1, wherein the lamp is a compact fluorescent lamp.

13. A circuit arrangement for a lamp configured to operate according to a method as claimed in claim 1.

14. A compact fluorescent lamp comprising a controller as claimed in claim 9.
